(19) United States
(12) Patent Application Publication
(10) Pub. No.: US 2013/0148154 A1
(43) Pub. Date: Jun. 13, 2013

(54) PRINTING SYSTEM, IMAGE FORMING APPARATUS, CONTROL METHOD THEREFOR AND COMPUTER-READABLE MEDIUM

(71) Applicant: CANON KABUSHIKI KAISHA, Tokyo (JP)

(72) Inventor: Akio Ito, Yokohama-shi (JP)

(73) Assignee: CANON KABUSHIKI KAISHA, Tokyo (JP)

(21) Appl. No.: 13/676,619

(22) Filed: Nov. 14, 2012

(30) Foreign Application Priority Data
Dec. 7, 2011 (JP) 2011-268366

(51) Int. Cl. G06K 15/02

(52) U.S. Cl. CPC G06K 15/02
USPC 358/1.15

(57) ABSTRACT

An image forming apparatus for being communicably connected to a server that manages messages complying with rules of a short sentence communication service from the image forming apparatus and responds by the messages to requests from an information processing terminal, comprises: an acquisition unit configured to acquire internal information of the apparatus itself; a generation unit configured to generate, in accordance with conditions set beforehand, distribution data including a message that complies with the rules of the short sentence communication service and concerns the information acquired by the acquisition unit, coordinate information about the apparatus itself, and position information for communicating with the apparatus itself via a predetermined network; and a distribution unit configured to distribute the distribution data generated by the generation unit to the server.

### BACKGROUND OF THE INVENTION

1. Field of the Invention

The present invention relates to a printing system, an image forming apparatus, a control method therefor, and a computer-readable medium. In particular, it relates to an image forming apparatus comprising a data distribution function.

2. Description of the Related Art

In recent years, with the advancement of technology related to mobile devices typified by the smartphone, new information dissemination services are being born. For example, there is a short sentence communication service called Twitter° that publishes tweets® (short messages) of individual users within a given number of characters.

In addition, in mobile devices functions for acquiring position information of their own, such as GPS (Global Positioning System), are being installed. There are services that display such position information acquisition functions combined with information disseminated on Twitter® etc. For example, at “Sekai Camera®” by Tonchidot Corp., images captured by cameras of smartphones and other information terminals are displayed with superimposed information about the location or object photographed. In this way, it is possible to present an augmented reality, obtaining a sensation as though a tag had been attached to the object or location. Further, in Japanese Patent Laid-Open No. 2010-219879, a technology is disclosed that, displays help information acquired from a help server superimposed on a captured image on a mobile device or similar information terminal.

It is envisaged that in the future, in order to use augmented reality related technology as in Sekai Camera®, also image forming apparatuses etc. will disseminate help information and the like together with position information of the installation site. However, even if one could see such information from an information terminal, this would not mean that conventional services provided by the image forming apparatus, such as printing, could be used from the information terminal. Specifically, it would be necessary to obtain and manage, at the information terminal, necessary information depending on the service, such as network information and machine type information of the image forming apparatus, how to specify print settings and a document to be printed when printing.

In this case, the image forming apparatus would be required to supply image forming apparatus information that is considered necessary in the service requested by the information terminal, in a format corresponding to the above-described technology.

### SUMMARY OF THE INVENTION

According to one aspect of the present invention, there is provided an image forming apparatus for being communicably connected to a server that manages messages complying with rules of a short sentence communication service from the image forming apparatus and responds by the messages to requests from an information processing terminal, comprising: an acquisition unit configured to acquire internal information of the apparatus itself; a generation unit configured to generate, in accordance with conditions set beforehand, distribution data including a message that complies with the rules of the short sentence communication service and concerns the information acquired by the acquisition unit, coordinate information about the apparatus itself, and position information for communicating with the apparatus itself via a predetermined network; and a distribution unit configured to distribute the distribution data generated by the generation unit to the server.

According to another aspect of the present invention, there is provided a printing system wherein an image forming apparatus and a server that manages messages complying with rules of a short sentence communication service from the image forming apparatus and responds by the messages to requests from an information processing terminal are communicably connected, the image forming apparatus comprising: an acquisition unit configured to acquire internal information of the apparatus itself; a generation unit configured to generate, in accordance with conditions set beforehand, distribution data including a message that complies with the rules of the short sentence communication service and concerns the information acquired by the acquisition unit, coordinate information about the apparatus itself, and position information for communicating with the apparatus itself via a predetermined network; and a distribution unit configured to distribute the distribution data generated by the generation unit to the server.

According to another aspect of the present invention, there is provided a method of controlling an image forming apparatus communicably connected to a server that manages messages complying with rules of a short sentence communication service from the image forming apparatus and responds by the messages to requests from an information processing terminal, comprising: acquiring internal information of the apparatus itself; generating, in accordance with conditions set beforehand, distribution data including a message that complies with the rules of the short sentence communication service and concerns the information acquired in the acquisition step, coordinate information about the apparatus itself, and position information for communicating with the apparatus itself via a predetermined network; and distributing the distribution data generated in the generation step to the server.

According to the present invention, position information and information of an image forming apparatus are enabled to be distributed in combination. Thus it is possible to support also systems that display information of image forming apparatuses, and print when an image forming apparatus is selected.

Further features of the present invention will become apparent from the following description of exemplary embodiments (with reference to the attached drawings).

### BRIEF DESCRIPTION OF THE DRAWINGS

FIG. 1 is a block diagram showing the configuration of a printing system.

FIG. 2 is a block diagram showing the internal configuration of an image forming apparatus.

FIG. 3 is a block diagram showing the internal configuration of a server.

FIG. 4 is a block diagram showing the internal configuration of an information processing terminal.

FIGS. 5A, 5B are views illustrating an external appearance of the information processing terminal.

FIG. 6 is a schematic flowchart of the overall operation of the printing system according to a first embodiment.

FIG. 7 is a data distribution flowchart of the image forming apparatus.

FIG. 8 is a diagram showing an example of a data distribution setting screen.

FIG. 9 is a diagram showing an example of a detected events setting screen.

FIG. 10 is a diagram showing an example of a normal state detected events setting screen.

FIG. 11 is a diagram showing an example of an error state detected events setting screen.

FIG. 12 is a diagram showing an example of a service error state detected events setting screen.

FIG. 13 is a diagram showing an example of an another detected events setting screen.

FIG. 14 is a diagram showing an example of a position information display and setting screen.

FIG. 15 is a diagram showing an example of an apparatus information display and setting screen.

FIG. 16 is a diagram showing an example of a data distribution destination display and setting screen.

FIG. 17 is a diagram showing an example of a data distribution timing setting screen.

FIG. 18 is a diagram showing an example of a distribution data format.

FIG. 19 is a diagram illustrating a specific example of distribution data.

FIG. 20 is a diagram showing a display example of distribution data of the information processing terminal 400.

FIG. 21 is a diagram showing a display example of distribution data of the information processing terminal 400.

### DESCRIPTION OF THE EMBODIMENTS

Hereinafter, an embodiment for carrying out the present invention will be described with reference to the drawings. The present invention is not limited to the configuration shown in the following embodiment.

### First Embodiment

### <Configuration of Printing System>

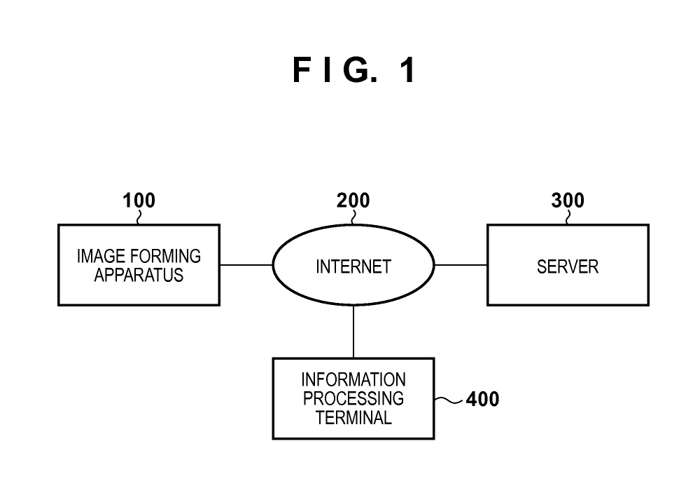

The system configuration of the present invention will be explained. FIG. 1 is a diagram showing an overall configuration of a printing system according to the present embodiment. This system is composed of an image forming apparatus 100, a server 300, and an information processing terminal 400, which are connected via the Internet 200. Each component is assumed to have been granted an IP address for identifying devices over the network. Here, each two of the apparatuses are assumed to be communicably connected. In the present embodiment, the information processing terminal 400 is assumed to be a mobile terminal that a user can hold and carry about, for example such as a smartphone. Further, although in FIG. 1 the image forming apparatus 100 and the server 300 are shown as single structures, they are not limited thereto. For example, multiple physical devices may as well realize the function of server 300 cooperatively.

### <Hardware Configuration>

### (Image Forming Apparatus)

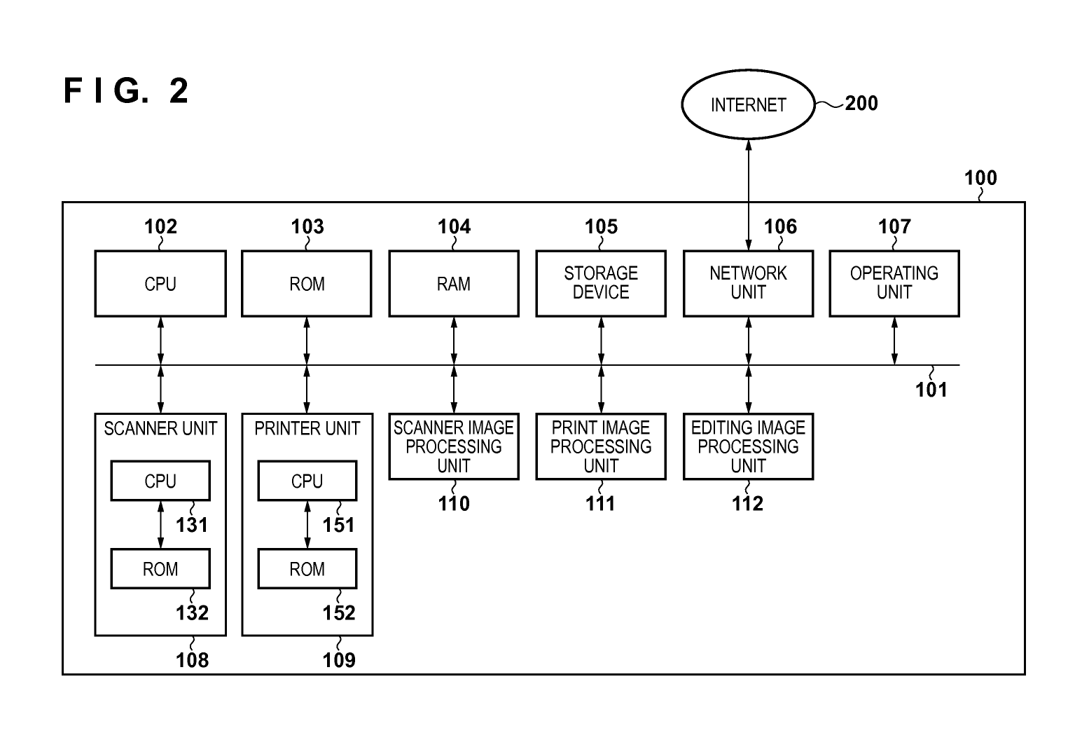

FIG. 2 is a block diagram illustrating the internal configuration of the image forming apparatus 100 shown in FIG. 1. Individual units in the image forming apparatus 100 are electrically connected via a system bus 101. CPU 102 is a central calculation unit for controlling the entire image forming apparatus 100. ROM 103 stores a program to be run by CPU 102 at startup of the image forming apparatus 100. RAM 104 is a work memory for temporarily storing data used by CPU 102 for calculation. A storage device 105, which consists e.g. of a hard disk drive (HDD), holds software and settings for control of the image forming apparatus 100, saved documents, and the like.

A network unit 106, being an interface to the Internet 200, is responsible for input and output of information from/to other information devices over the Internet 200. An operating unit 107 is responsible for control in accordance with operations from the user. The operating unit 107 comprises a display, for example a liquid-crystal operation panel (not shown) composed of a liquid-crystal display and a touch panel etc. A scanner unit 108 includes an illumination lamp, scanning mirror etc. (not shown) for performing document reading. A printer unit 109 includes a photosensitive drum and a fixing device (not shown) for performing image formation and fixing. A scanner image processing unit 110 performs image processing such as correction, processing, and conversion with respect to image data inputted from the scanner unit 108.

A print image processing unit 111 performs image processing such as correction, processing, and conversion with respect to image data to be outputted (printed) to the printer unit 109. An editing image processing unit 112 performs JPEG, JBIG, MMR, or MH image compression and decompression processing, as well as rotation of image data. In FIG. 2, the scanner unit 108 and the printer unit 109 are respectively provided with internal CPUs 131, 151 and ROMs 132, 152. The CPUs 131, 151 perform processing in accordance with programs stored respectively in the ROMs 132, 152. Also, each of the CPUs 131, 151 performs communication when needed with CPU 102, to execute control of the scanner unit 108 and printer unit 109 following the instructions of CPU 102.

A position information acquisition unit 113 includes a sensor for detecting coordinate information such as latitude and longitude (Geolocation) as well as height information, to acquire position information of the apparatus. Further, CPU 102 accesses a map information server on the Internet to obtain the location name (address) based on the position information.

On the CPUs 131, 151 of the scanner unit 108 and printer unit 109, for example, a normal operation management program, a power state management program, an error management program, a service information management program and the like are running. With these programs, the finer control and management of document reading, printing to paper, and other tasks is performed. Various types of event information detected by execution of the programs are reported from the CPUs 131, 151 of the scanner unit 108 and printer unit 109 to CPU 102. Additionally, the CPUs 131, 151 report event information in response to requests of CPU 102. Regarding the events reported here, there is e.g. original/printing paper information, power control information, job execution information, error information (information on paper jam, out of toner, abnormal temperature, abnormal operation etc.), and so forth. Events dealt with are not limited to those described above, but may e.g. be targeted to state changes occurring within the image forming apparatus 100 and the like.

When an event occurs, the image forming apparatus 100 issues distribution data and distributes it to the server 300. This process will be described later.

### (Server)

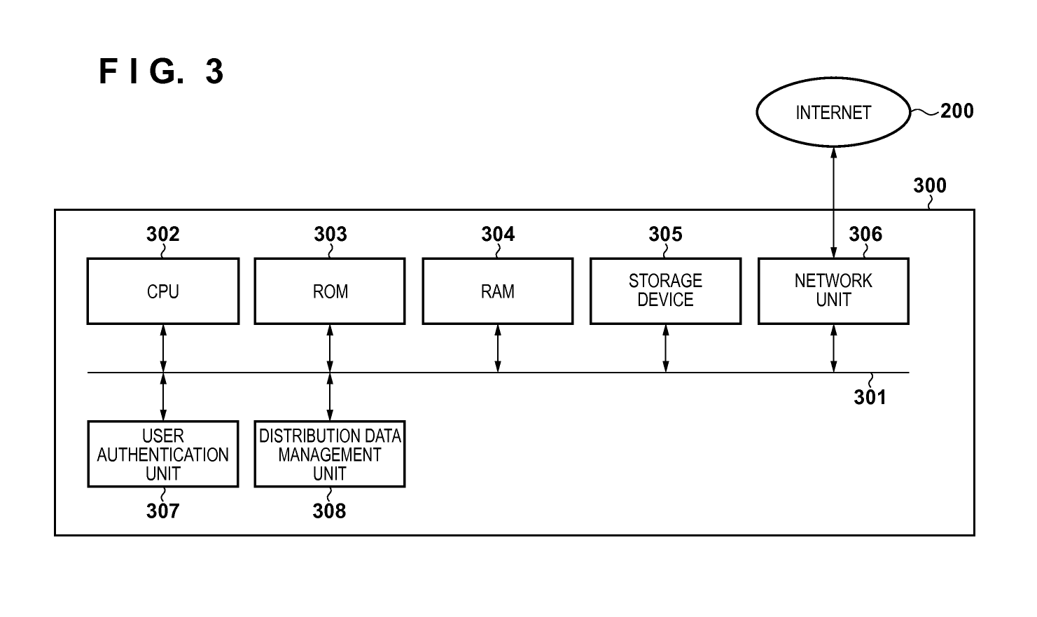

FIG. 3 is a block diagram illustrating the internal configuration of the server 300 shown in FIG. 1. Individual units in the server 300 are electrically connected via a system bus 301. CPU 302 is a central calculation unit for controlling the entire server 300. ROM 303 stores a program to be run by CPU 302 at startup of the server 300. RAM 304 is a work memory for temporarily storing data used by CPU 302 for calculation. A storage device 305, which consists for example, of a hard disk drive (HDD), stores programs and data of various types used by the server 300. Further, the storage device 305 stores data distributed by the image forming apparatus 100 over the Internet 200.

A network unit 306, being an interface to the Internet 200, is responsible for input and output of information from/to other information devices over the Internet 200. A user authentication unit 307 performs authentication of users who log in to the server 300. For example, when the image forming apparatus 100 distributes information, the distribution will be performed after logging in to the server 300. A distribution data management unit 308 manages the data distributed by the image forming apparatus 100. For example, the distribution data management unit 308 links distribution data with user names, or sets browsing rights by user name.

### (Information Processing Terminal)

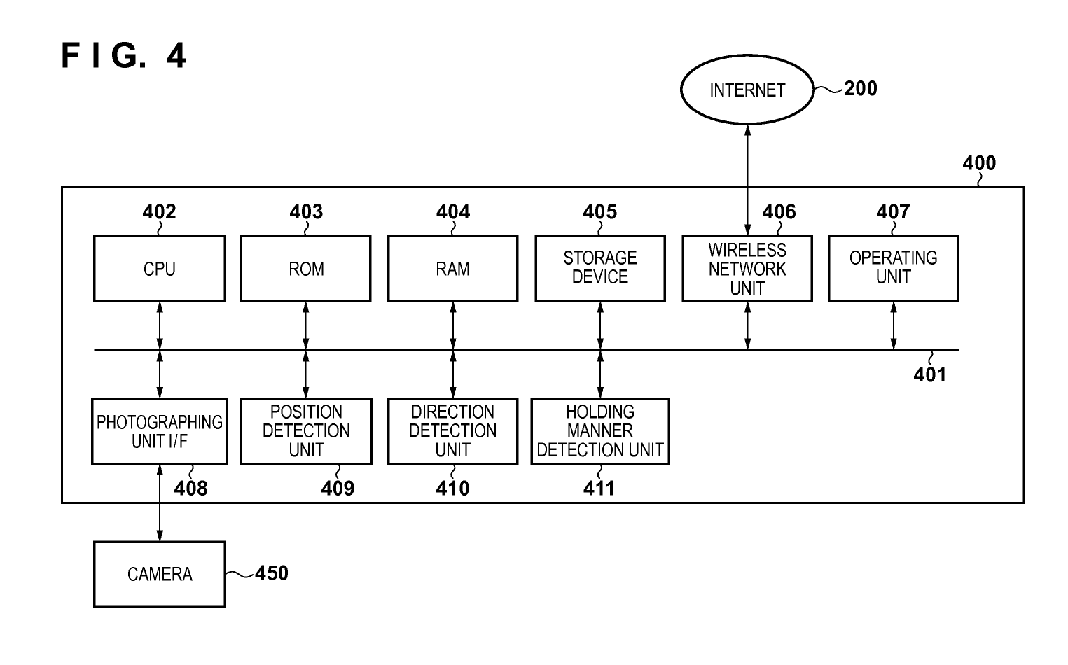

FIG. 4 is a block diagram illustrating the internal configuration of the information processing terminal 400 shown in FIG. 1. Individual units in the information processing terminal 400 are electrically connected via a system bus 401. CPU 402 is a central calculation unit for controlling the entire information processing terminal 400. ROM 403 stores a program to be run by CPU 402 at startup of the information processing terminal 400. RAM 404 is a work memory for temporarily storing data used by CPU 402 for calculation.

A storage device 405, which consists for example, of flash ROM, stores programs and data of various types used by CPU 402. Wireless network unit 406 is an interface for communicating with the Internet 200 via wireless communications such as wireless LAN. An operating unit 407 performs input and output of information between the user and the information processing terminal 400. Photographing unit I/F 408 is an interface for receiving an image that has been acquired using a camera 450 being the photographing unit. Note that, in FIG. 4, the camera 450 is shown outside the information processing terminal 400, but may be configured to be included therein.

A position detection unit 409, using a GPS receiver or the like (not shown), performs identification of the current location of the information processing terminal 400. A direction detection unit 410, using a geomagnetic sensor or the like (not shown), detects the direction the information processing terminal 400 is currently facing. A holding manner detection unit 411, using an acceleration sensor or the like (not shown), detects whether the user is holding the information processing terminal 400 in portrait orientation, or is holding it in landscape orientation.

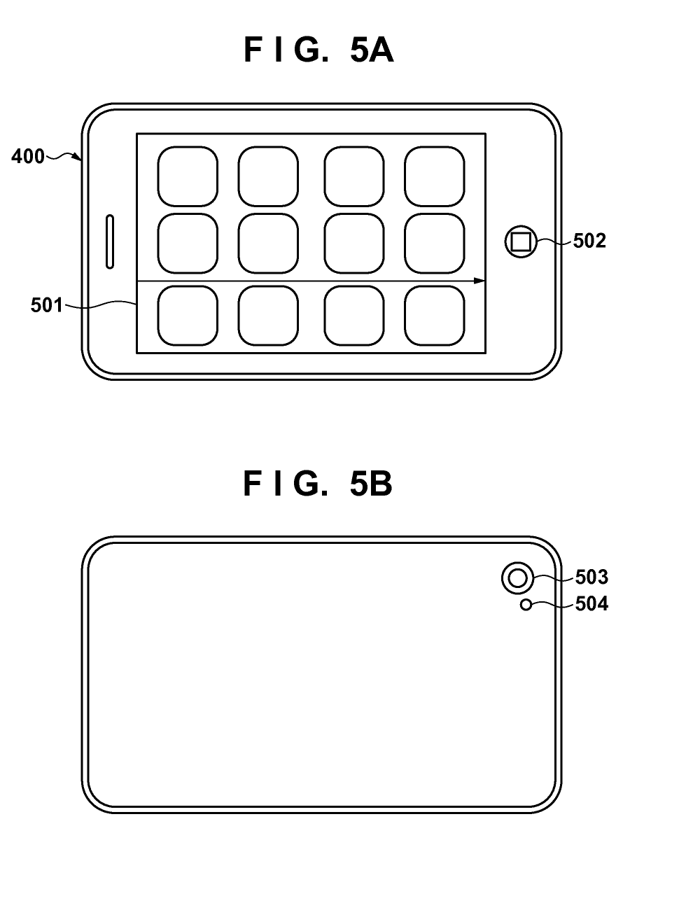

FIGS. 5A, 5B are views illustrating examples of an external appearance of the information processing terminal 400. FIG. 5A is an example of the appearance of the front surface of the information processing terminal 400. Touch panel 501 is a liquid crystal touch panel for presenting information to the user and receiving input from the user. In this embodiment, the liquid crystal touch panel is used to realize a reception unit. It is assumed that, depending on the touch duration during input, the touch panel 501 is able to distinguish between a normal tap (press) and a long-time tap (press and hold). Home button 502 is used e.g. to suspend the application running in the information processing terminal 400, to return to the home screen. FIG. 5B is an example of the appearance of the back surface of the information processing terminal 400. Camera 503 is a camera for photographing the surroundings. Flash 504 is a flash for assisting the photographing with the camera 503.

Here, the term “distribution data” as used in the present description shall be commented on. For example, distribution data applies to a tweet® on the above-mentioned short sentence communication service Twitter®, and the like. Typically, such a short sentence communications service imposes a restriction regarding the maximum number of characters that can be included per one message such as a tweet®. In this embodiment, the image forming apparatus 100 is assumed to issue, as distribution data, short messages depending on its state (events etc.) within the maximum number of characters allowed by the rules of a short sentence communications service.

### <Overall Flow of Printing System>

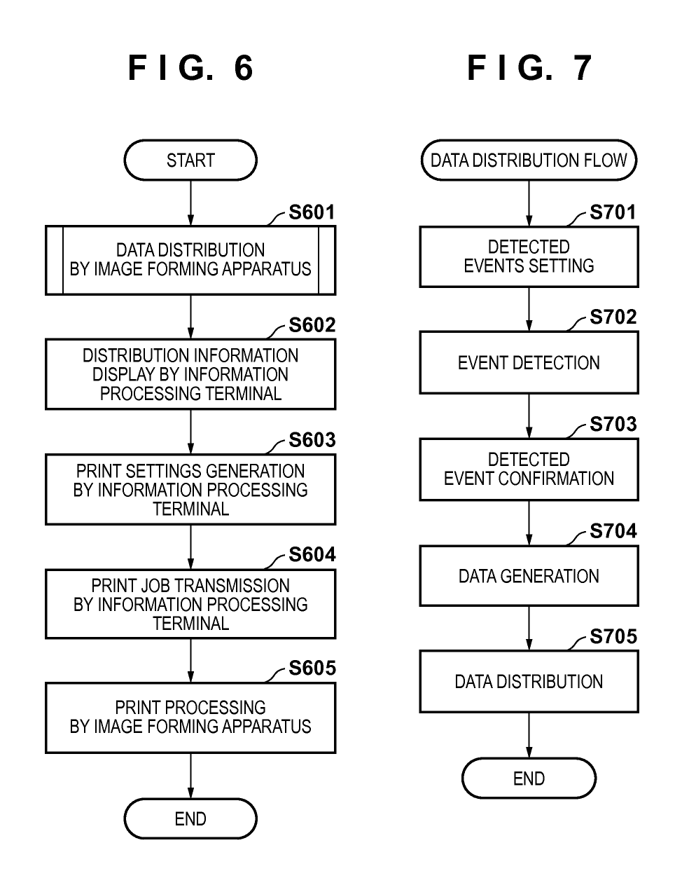

In FIG. 6, an overall flowchart is shown wherein, in use of the present printing system, the image forming apparatus 100 distributes data depending on the state of the apparatus, and a printing instruction is given from the information processing terminal 400.

First, in 5601 the image forming apparatus 100 distributes data. The details will be described later with reference to FIG. 7. Then, in 5602 the information processing terminal 400 displays the distribution data. By accessing the server 300, the information-processing terminal 400 is able to receive the data distributed to the server 300 from the image forming apparatus 100, to display the distribution data in accordance with display software (not shown) in the information-processing terminal 400. The display of the distribution data can be performed while the information-processing terminal 400 and the server 300 sequentially transfer required data.

For displaying the distribution data, there are various methods. For example, there are methods that display the distribution data in chronological order, methods that display the distribution data superimposed on map data by using position information in the information distributed, or methods that display the distribution data overlaid on an image photographed by the camera 450 of the information processing terminal 400.

In S603, information processing terminal 400 performs print settings. The distribution data from the image forming apparatus 100 includes a URL (Uniform Resource Locator)/IP address. Therefore, the information processing terminal 400 can perform the print settings by selecting and designating the URL/IP address. In S604, the information processing terminal 400 sends a print job to the image forming apparatus 100 selected in S603. In this case, the information processing terminal 400 sends a print job for a URL/IP address selecting the file to be printed. Finally, in S605, the image forming apparatus 100 performs the print processing of the print data received.

Through data distribution in accordance with the state of the image forming apparatus 100, the present invention enables the user receiving the distribution data to more easily understand the state of the apparatus. Furthermore, by adding apparatus information of the image forming apparatus 100 to the distribution data, the user can detect the image forming apparatus 100 with the distribution data easier.

### <Data Distribution Flow>

The creation of the distribution data, as well as the data distribution method, which characterize the present invention, will be explained below. FIG. 7 is a flowchart showing an information distribution flow. Each step in the flowchart of FIG. 7 is performed by the CPU 102 of the image forming apparatus 100 reading and executing a program stored in the storage device 105.

S701 is a detected events setting step. Setting and registration is performed for the image forming apparatus 100 to detect events that occur internally, such as at the scanner unit 108 and printer unit 109, and distribute the detected event information. Examples of events that can be set here are power on/off, entering/leaving power saving mode, jam occurrence/resolution, out of toner occurrence/resolution, out of paper occurrence/resolution, service information, and so on. Data is distributed to a predetermined destination when the events set occur.

Setting of the destination for sending the distribution data and of the position information of the image forming apparatus 100 is also performed in step S701. The setting of data is carried out by having the user select and designate setting items displayed on the operating unit 107. Further, the user may set the setting items also via the network unit 106 from the Internet 200. The settings are recorded in the storage device 105. At the time of executing the information distribution flow, the setting information is sent from the storage device 105 to the RAM 104 for accelerated process execution.

S702 is an event detection step. The image forming apparatus 100 is in a state waiting for the occurrence of the event that has occurred. The event information detected at the scanner unit 108 and printer unit 109 is transmitted to the CPU 102, such that the CPU 102 is in a position to constantly monitor the state of the entire image forming apparatus 100. S703 is an event confirmation step. The image forming apparatus 100 performs a confirmation whether the event detected in S702 is an event that was set in S701.

S704 is a data generation step. The image forming apparatus 100 generates the distribution data. If the occurrence of a set event was confirmed in S703, the image forming apparatus 100 performs the generation of the distribution data in response to the event. The current position information and the URL of the image forming apparatus 100 are added to the distribution data that is generated. The current position information of the image forming apparatus 100 may be configured to be input by the user from the operating unit 107, or may as well be acquired from a GPS or other position-detecting unit.

S705 is a data distribution step. The image forming apparatus 100 sends the distribution data generated in S704 to the server 300. The CPU 102 of the image forming apparatus 100 creates the distribution data within the RAM 104, and sends it via the network unit 106 and the Internet 200 to the server 300, using the transmit destination set in the storage device 105.

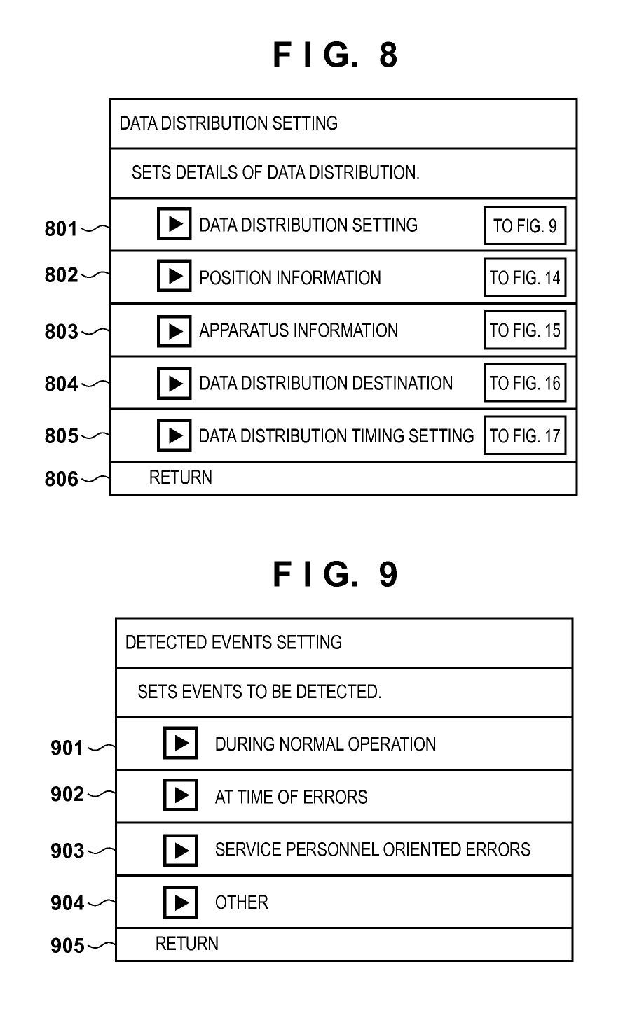

The following describes the data distribution flow in detail. FIG. 8 through FIG. 17 show specific examples of the setting screens displayed on the operating unit 107 in the detected events setting step (S701) of FIG. 7.

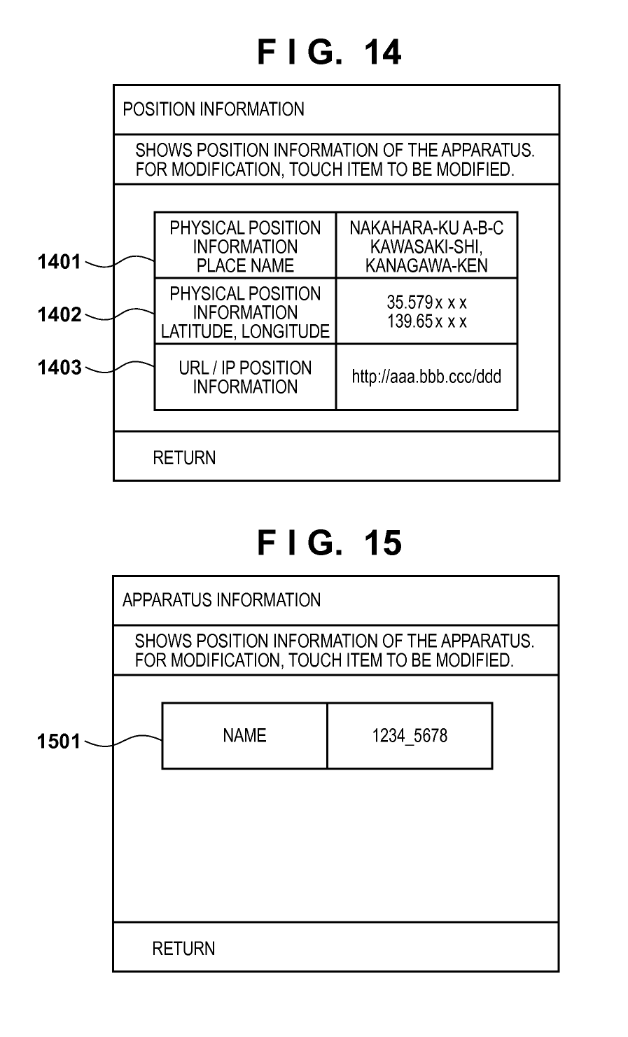

FIG. 8 shows one example of a data distribution setting screen, which displays a list of setting items, wherein pressing a button of each item proceeds to a respective detail setting screen. The button of each item is an item that is displayed on the operating unit 107. A data distribution setting button of item 801, when pressed by the user, proceeds to a detailed data distribution setting screen shown in FIG. 9. A position information button at item 802, when pressed by the user, proceeds to a display screen/modifying screen for the position information of the apparatus shown in FIG. 14.

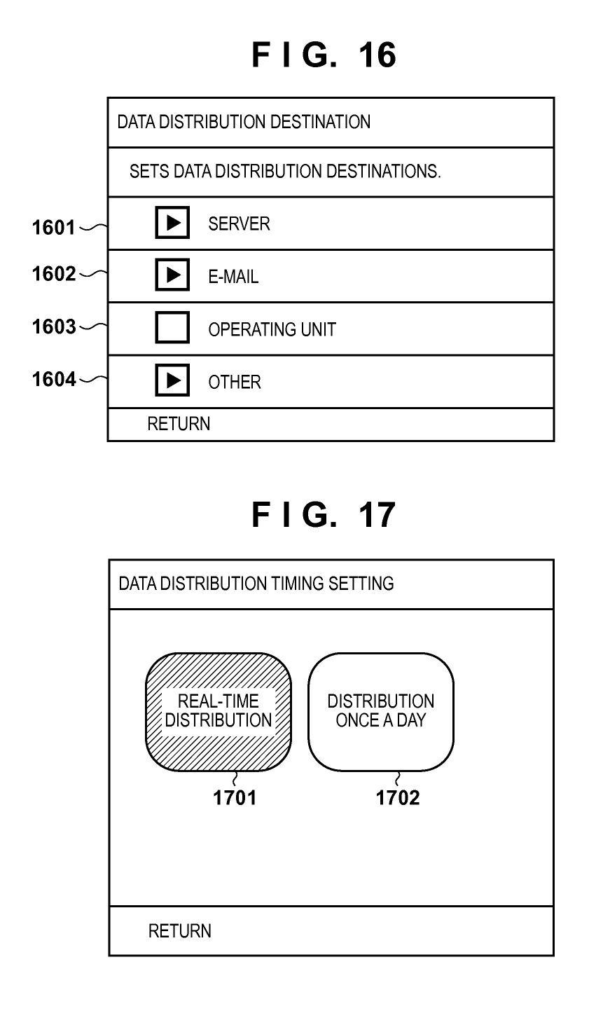

An apparatus information button at item 803, when pressed by the user, proceeds to an apparatus information screen shown in FIG. 15. A data distribution destination button at item 804, when pressed by the user, proceeds to setting screen for the data distribution destination shown in FIG. 16. A data distribution timing button at item 805, when pressed by the user, proceeds to a screen for setting the distribution timing for the data shown in FIG. 17. A return button 806 is used when exiting the present setting screen. It is noted that also the screens shown in the following figures are provided with a return button, which has the same function.

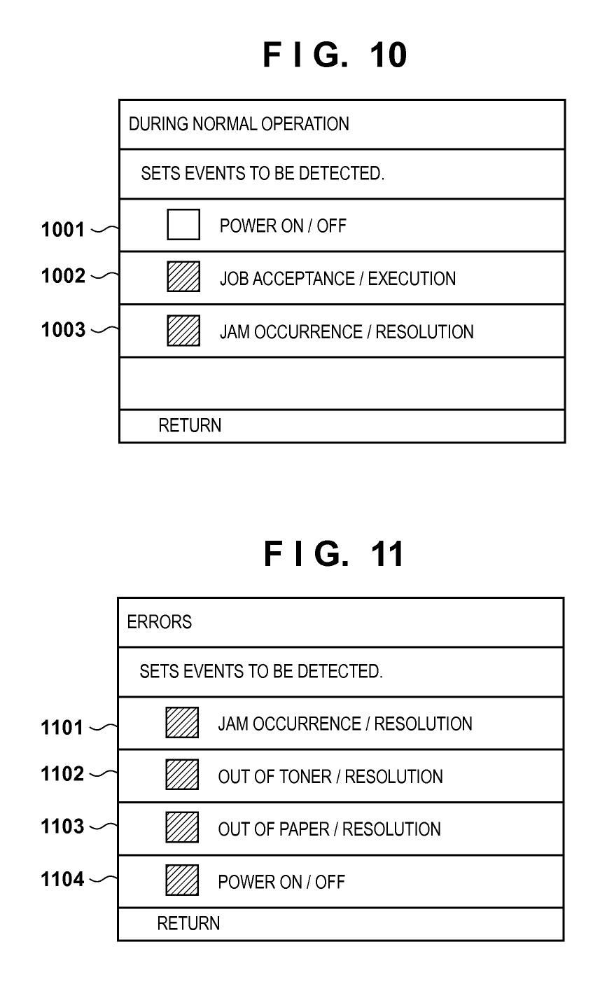

FIG. 9 shows one example of a detected events setting screen that lists setting items for events to be detected as distribution data, wherein pressing a button of each item proceeds to a respective detail setting screen. A normal operation state setting button at item 901, when pressed by the user, proceeds to a screen for normal operation state distribution setting, shown in FIG. 10. An error occurrence state setting button at item 902, when pressed by the user, proceeds to a screen for performing error occurrence state distribution setting, shown in FIG. 11.

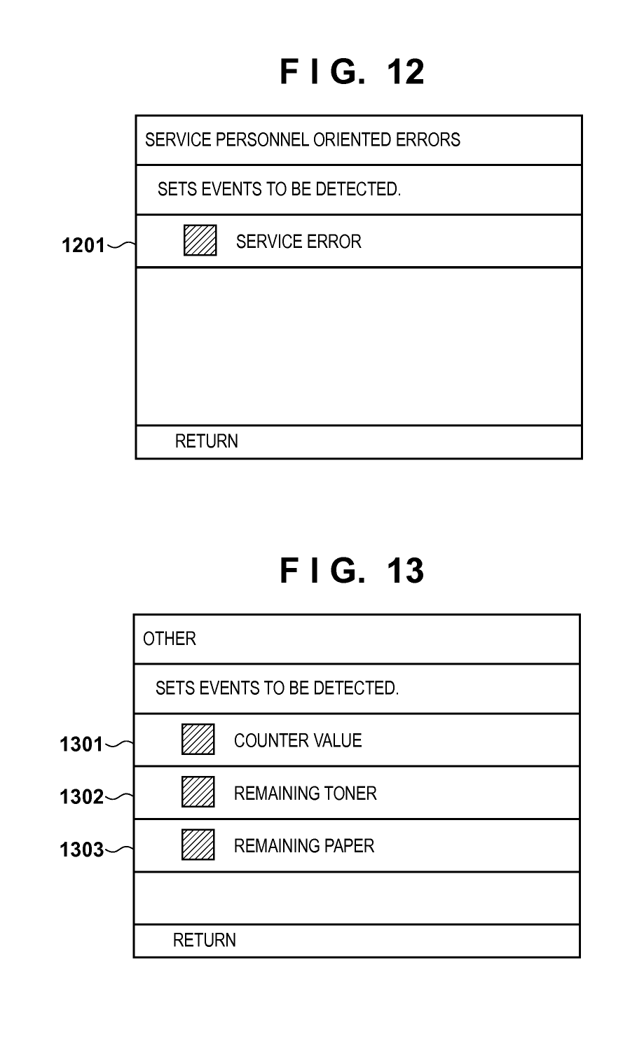

A service personnel oriented error occurrence state setting button at item 903, when pressed by the user, proceeds to a screen for performing service error occurrence state distribution setting, shown in FIG. 12. An other setting items button at item 904, when pressed by the user, proceeds to a screen for performing distribution setting concerning other items, shown in FIG. 13.

FIG. 10 shows one example of a detail setting screen for data distribution to be performed during normal operation. In FIG. 10, it is possible to set whether data distribution shall be performed for the power state or job acceptance/execution. Item 1001 is set by button pressing if data distribution is to be performed at the time of power ON/OFF of the apparatus. Item 1002 is set by button pressing if data distribution is to be performed at the time of job acceptance/execution. Item 1003 is set by button pressing if data distribution is to be performed at the time of jam occurrence/resolution. In the present embodiment, buttons are meant to be selected (ON) when shaded, and non-selected (OFF) when white, which is valid also for the remaining screens.

FIG. 11 shows one example of a detail setting screen for data distribution to be performed at a time of error occurrence. If a respective selected item among items 1101-1104 happens, the image forming apparatus 100 performs the distribution of data. Item 1101 is a setting item for jam occurrence/resolution, item 1102 for out of toner occurrence/resolution, item 1103 for out of paper occurrence/resolution, and item 1104 for power ON/OFF. It should be noted that the setting items are not limited to the above, and settings for other errors in accordance with functions etc. of the image forming apparatus 100 may also be provided.

FIG. 12 shows one example of a detail setting screen for data distribution to be performed at a time of occurrence of a service personnel oriented error. If data distribution shall be performed in cases when an error irrecoverable by the user has occurred, this is set with item 1201.

FIG. 13 shows one example of a detail setting screen for data distribution to be performed when events other than errors and service errors are detected. As data distribution selection items, there are item 1301 concerning a counter value, item 1302 concerning a toner remaining amount, and item 1303 concerning an amount of paper remaining. The user can select from these where data distribution is desired.

FIG. 14 shows one example of a display screen for apparatus position information. Position information 1401 and position information 1402 show physical position information of the image forming apparatus 100, while position information 1403 shows logical position information of the image forming apparatus 100. Position information 1401 shows the physical position information in terms of a place name of the present location of the image forming apparatus concerned, while position information 1402 shows GPS information in terms of latitude and longitude. Relying on the GPS position information of position information 1402, the image forming apparatus 100 accesses a map server providing map-information (not shown) on the network, to acquire and display map information. Position information 1403 shows the logical position information in terms of a location on the network. Moreover, by selecting each position information item, modification of the data can be performed.

FIG. 15 shows one example of a screen showing apparatus information. The user may set an apparatus name at a name information 1501. In addition, other apparatus information may be enabled to be set.

FIG. 16 shows one example of a screen for setting the data distribution destination. As the data distribution destination, one or more addresses may be selected from settings for sending to a server, mail, operating unit, or other type of address. When setting, each button corresponding to items 1601, 1602, and 1604 is pressed to set precise addresses etc. If operating unit at item 1603 is selected, the distribution data is displayed in the lower portion of the operating unit 107. Besides, other distribution destinations may be enabled to be set as well.

FIG. 17 shows one example of a screen for setting the timing of data distribution. In this embodiment, which provides real-time distribution 1701 and distribution once a day 1702 as two modes of distribution, it is possible to select either. Real-time distribution 1701 is a distribution mode in which distribution is performed consecutively when the conditions set in FIG. 9 through FIG. 13 as detected events occur. Distribution once a day 1702, different from real-time distribution, is a mode in which data is distributed collectively once a day. In addition, settings to enable distribution with other timings may be further provided.

Items set in FIG. 8 through FIG. 17, which have been described above, are stored in the storage device 105 of the image forming apparatus 100. The data stored in the storage device 105 is sent to the RAM 104 at startup of the image forming apparatus 100, to enable high-speed access from the CPU 102.

The image forming apparatus 100, by event detection (S702) and detected event confirmation (S703), monitors events of the image forming apparatus 100 in accordance with the items set on the screens shown in FIG. 8 through FIG. 15. When an event occurs that corresponds to an item that has been set, the image forming apparatus 100 proceeds to the step of data generation (S704).

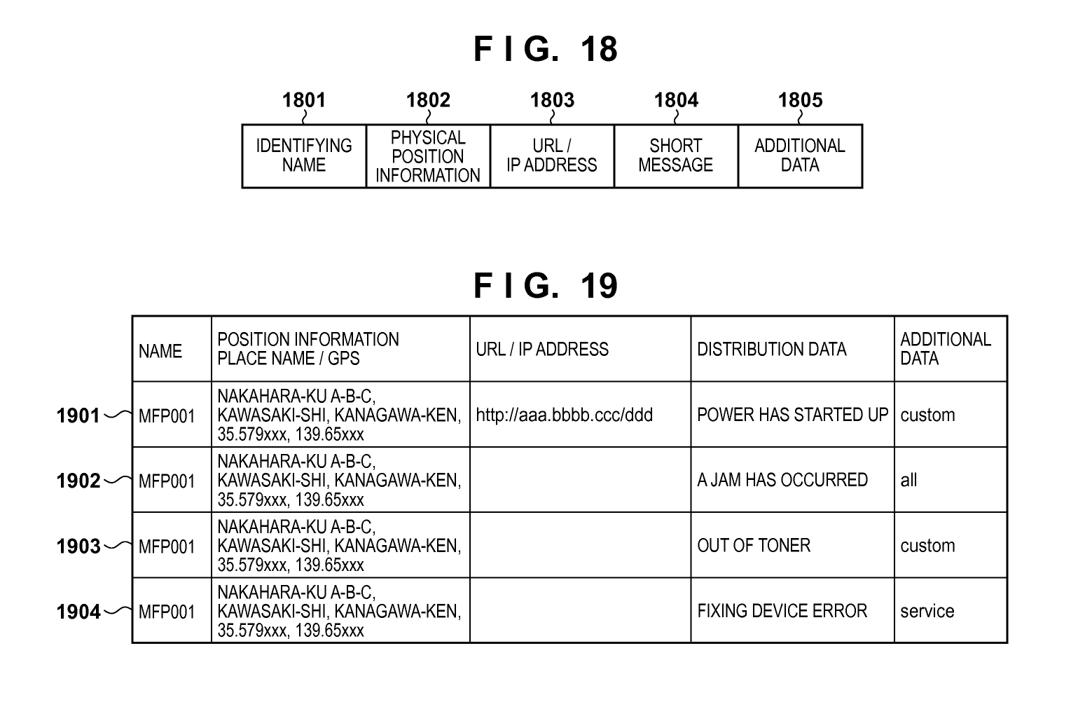

The data generation (S704) and data distribution (S705) shown in FIG. 7 will be described in detail by reference to FIG. 18 and FIG. 19.

FIG. 18 shows one example of a format of distribution data to be generated.

In the present embodiment, the distribution data is composed of an identifying name 1801, a physical position information 1802, a URL/IP address 1803, a short message 1804, and additional data 1805. The identifying name 1801 is an item that is set in the name information 1501 in FIG. 15. The physical position information 1802 is an item displayed as position information 1401 and position information 1402 in FIG. 14. Likewise, the URL/IP address 1803 refers to an item displayed as position information 1403 in FIG. 14.

The short message 1804 is data that is created in accordance with the distribution setting items set in FIG. 8 through FIG. 13. Examples of specific message content are “Power has started up”, “Out of toner”, and so forth. The additional data 1805 is data to be added in addition to the above as distribution data, and in the present embodiment refers e.g. to identification information for identifying users (or groups) to whom the short message is intended to be released. Specifically, by adding “service” as identification information to short messages corresponding to service personnel oriented error events, it is possible to distribute short messages that are not released to users in general.

FIG. 19 shows an example of distribution data of the image forming apparatus 100. Distribution data 1901, 1902, 1903, and 1904 are shown as distributed in sequence. Each distribution data, in accordance with the format shown in FIG. 18, comprises an identifier (name), a position information (place name/GPS), a URL/IP address, distribution data, and additional data. In addition, a priority depending on a distribution condition (setting) may be set in advance, such that distribution data satisfying the condition is distributed first.

For example, compared to normal events, error state events may be set to be distributed with priority. Further, if the distribution data contains a message indicating that the image forming apparatus is a state in which it cannot perform processing such as printing, a URL/IP address information may be omitted to prevent a print job from being requested, as is illustrated by distribution data 1902 and 1903. Further, also in case of the distribution data being intended for particular users (especially service personnel and the like), in contrast to ordinary users, no printing is performed. Therefore, as illustrated by distribution data 1904, the URL/IP address information may as well be omitted. Besides, the image forming apparatus 100 is configured to issue distribution data containing information about the URL/IP address again when, after an error has occurred, having recovered from the error. Thus, when the user browses a message indicating the recovery, a print request appropriately is enabled to be performed using the URL/IP address.

In FIG. 19, the type of distribution event has been included as additional data. Items corresponding to normal detected events in FIG. 10 have been assigned “all”, not limiting the release destination. Further, “custom” has been assigned to detected events corresponding to the errors in FIG. 11, and “service” to the service personnel oriented errors in FIG. 12. Other items are assigned “etc”. On the data receiving side, it is possible to differentiate display, processing and the like according to the data of this item.

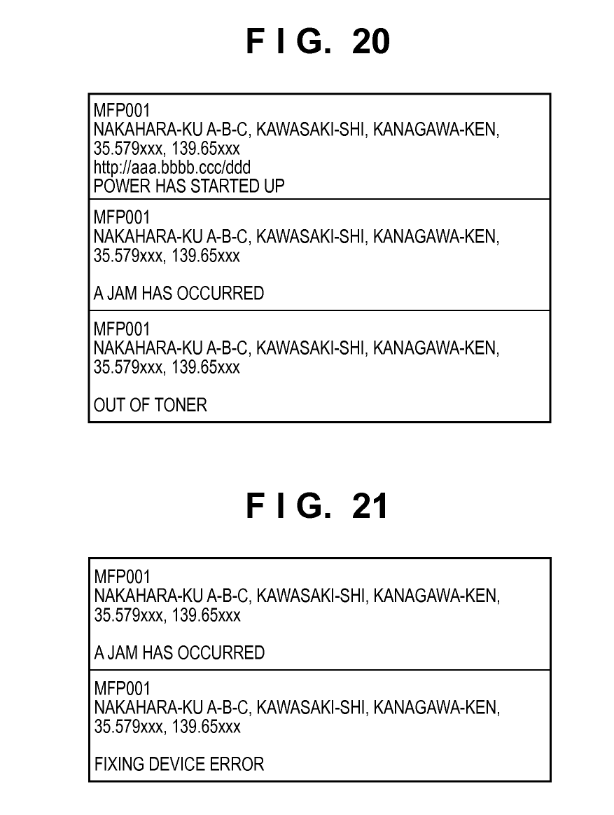

FIG. 20 shows a display example at the information processing terminal 400, in a case where a general user has logged in to a short sentence communication service using the information processing terminal 400. Distribution data generated and distributed by the image forming apparatus 100 is provided via the server 300 to the information processing terminal 400, and displayed. At the information processing terminal 400, it is possible to periodically (every few seconds) perform a request to the server 300 and display messages included in the received distribution data, under the control of software (not shown) in the information processing terminal 400.

FIG. 21 shows a display example at the information processing terminal 400, in a case where a service person has logged in to the short sentence communication service using the information processing terminal 400. Display control is as described with reference to FIG. 20. In this case, only those messages are displayed where the additional data in FIG. 19 indicates “service”.

While in the present embodiment the setting of the detection data is performed from the operating unit 107 of the image forming apparatus 100, the setting may as well be arranged to be performed over the network. Also, the distribution event types were listed in FIG. 19 as additional data. If the name of the manufacturer, the model name or the like are added as additional data, extraction from a great number of distribution events by specifying a manufacturer's name or model name becomes possible at the information processing terminal 400.

Moreover, the method described in the present embodiment may also be used to improve the operability of an image forming apparatus that lacks an operating unit or, even if having one, has restricted display functions, as a method to distribute the state of the image forming apparatus to an operator via the network.

### <Effects According to the Embodiment>

According to the present embodiment as described above, the image forming apparatus 100 is configured to create and distribute distribution data in accordance with the state of the image forming apparatus 100. This makes it easy to grasp the current status of the image forming apparatus 100 from the external information processing terminal 400.

Further, the data distributed by the image forming apparatus 100 contains various types of position information to search for the image forming apparatus 100. This facilitates finding the image forming apparatus 100 from the information processing terminal 400, and enables to immediately send a print job using the URL/IP address.

Through the above, it becomes possible to support also a system that displays information about image forming apparatuses based on position information of the image forming apparatuses, in order to print by making a selection from the displayed image forming apparatuses.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2011-268366, filed Dec. 7, 2011, which is hereby incorporated by reference herein in its entirety.

What is claimed is:

1. An image forming apparatus for being communicably connected to a server that manages messages complying with rules of a short sentence communication service from the image forming apparatus and responds by said messages to requests from an information processing terminal, comprising:
an acquisition unit configured to acquire internal information of the apparatus itself;
a generation unit configured to generate, in accordance with conditions set beforehand, distribution data including a message that complies with the rules of the short sentence communication service and concerns the information acquired by the acquisition unit, coordinate information about the apparatus itself, and position information for communicating with the apparatus itself via a predetermined network; and
a distribution unit configured to distribute the distribution data generated by the generation unit to the server.

2. The image forming apparatus according to claim 1, wherein the position information comprises at least one information selected from an IP address and a URL (Uniform Resource Locator).

3. The image forming apparatus according to claim 1, further comprising a reception unit for receiving a setting of the conditions from a user.

4. The image forming apparatus according to claim 3, wherein the reception unit further receives a setting of timing for distributing the distribution data, and the distribution unit distributes according to the timing.

5. The image forming apparatus according to claim 2, wherein in a case when the distribution data includes a message that the image forming apparatus is in a state unable to print, or in a case when the distribution data is data released to a particular release destination, the URL or IP address information is not added.

6. The image forming apparatus according to claim 2, wherein in a case when the distribution data includes a message that the image forming apparatus has recovered from a state unable to print, the at least one information selected from an IP address and a URL (Uniform Resource Locator) is included in the distribution data.

7. The image forming apparatus according to claim 1, wherein a degree of priority is set for the conditions, and distribution data including a message for information satisfying a condition with a higher degree of priority is distributed earlier.

8. A non-transitory computer-readable medium that stores a program for causing a computer to function as each unit according to claim 1.

9. A printing system wherein an image forming apparatus and a server that manages messages complying with rules of a short sentence communication service from the image forming apparatus and responds by said messages to requests from an information processing terminal are communicably connected, the image forming apparatus comprising:
an acquisition unit configured to acquire internal information of the apparatus itself;
a generation unit configured to generate, in accordance with conditions set beforehand, distribution data including a message that complies with the rules of the short sentence communication service and concerns the information acquired by the acquisition unit, coordinate information about the apparatus itself, and position information for communicating with the apparatus itself via a predetermined network; and
a distribution unit configured to distribute the distribution data generated by the generation unit to the server.

10. A method of controlling an image forming apparatus communicably connected to a server that manages messages complying with rules of a short sentence communication service from the image forming apparatus and responds by said messages to requests from an information processing terminal, comprising:
acquiring internal information of the apparatus itself;
generating, in accordance with conditions set beforehand, distribution data including a message that complies with the rules of the short sentence communication service and concerns the information acquired in the acquisition step, coordinate information about the apparatus itself, and position information for communicating with the apparatus itself via a predetermined network; and
distributing the distribution data generated in the generation step to the server.
